(19) United States
(12) Patent Application Publication
(10) Pub. No.: US 2019/0263173 A1
(43) Pub. Date: Aug. 29, 2019

(54) GRAPHICAL HEAT TRANSFER PRINTING STRUCTURE

(71) Applicants: Min San Huang, Nantou County (TW); Chia Rong Liu, New Taipei City (TW)

(72) Inventors: Min San Huang, Nantou County (TW); Chia Rong Liu, New Taipei City (TW)

(21) Appl. No.: 16/333,961

(22) PCT Filed: Sep. 20, 2016
(86) PCT No.: PCT/CN2016/000525

§ 371 Date: Mar. 15, 2019

(51) Int. Cl. B44C 1/16; B41M 5/382

(52) U.S. Cl. CPC B44C 1/16; B41M 5/382

(57) ABSTRACT

A graphical heat transfer printing structure contains: a flexible layer, an adhesion layer, and a fluff layer. The flexible layer is made of flexible materials, and the adhesion layer is made of adhesive flexible material and covers on a top of the flexible layer. Furthermore, the fluff layer is defined between the flexible layer and the adhesion layer, and the fluff layer includes multiple fluffs flocked on the flexible layer and into the adhesion layer.

### FIELD OF THE INVENTION

The present invention relates to a heat transfer printing structure, and more particularly to a graphical heat transfer printing structure which enhances adhesion of silicone and hot-melt adhesive by using multiple fluffs.

### BACKGROUND OF THE INVENTION

Conventional heat transfer printing patterns are formed in ink screen printing, and the patterns are printed on objects, such as clothes, in heat transfer printing manner. However, when the objects are pulled overly or distort, the patterns of the objects are broken or deform.

The silicone is flexible material, is not limited by color, and covers the objects brilliantly, so it is widely applicable for the heat transfer printing structure. Preferably, the silicone fixes the color brilliantly and having smooth touch.

But the silicone and the hot-melt adhesive cannot adhere firmly, and the silicone peels off easily after the hot-melt adhesive adheres on the objects for a period of time.

The present invention has arisen to mitigate and/or obviate the afore-described disadvantages.

### SUMMARY OF THE INVENTION

The primary aspect of the present invention is to provide a graphical heat transfer printing structure which enhances adhesion of silicone and hot-melt adhesive by using multiple fluffs.

To obtain above-mentioned aspect, a graphical heat transfer printing structure provided by the present invention contains: a flexible layer, an adhesion layer, and a fluff layer.

The flexible layer is made of flexible materials.

The adhesion layer is made of adhesive flexible material and covers on a top of the flexible layer.

Furthermore, the fluff layer is defined between the flexible layer and the adhesion layer, and the fluff layer includes multiple fluffs flocked on the flexible layer and into the adhesion layer.

Preferably, the flexible layer is made of any one of silicone, emulsion, polyurethane (PU) and thermoplastic polyurethane (TPU). Preferably, the adhesion layer is made of hot-melt adhesive or thermoplastic resin.

The fluff layer is flocked on the flexible layer and into the adhesion layer so that the fluff layer connects the flexible layer and the adhesion layer and firmly.

### BRIEF DESCRIPTION OF THE DRAWINGS

FIG. 1 is a cross sectional view showing the assembly of a graphical heat transfer printing structure according to a preferred embodiment of the present invention.

FIG. 2 is a cross sectional view showing the manufacture process of the graphical heat transfer printing structure according to the preferred embodiment of the present invention.

FIG. 3 is another cross sectional view showing the manufacture process of the graphical heat transfer printing structure according to the preferred of the present invention.

FIG. 4 is another cross sectional view showing the assembly of the graphical heat transfer printing structure according to the preferred embodiment of the present invention.

### DETAILED DESCRIPTION OF THE PREFERRED EMBODIMENTS

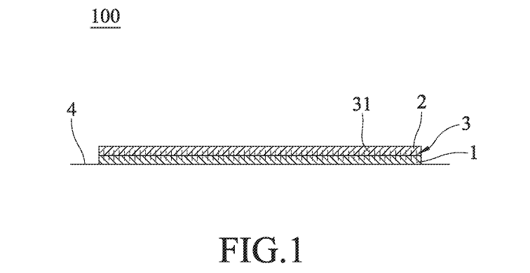

With reference to FIG. 1, a graphical heat transfer printing structure 100 according to a preferred embodiment of the present invention comprises: a flexible layer 1, an adhesion layer 2 connected on a top of the flexible layer 1, a fluff layer 3 configured to connect the flexible layer 1 and the adhesive layer 2.

The flexible layer 1 is made of flexible materials, such as silicone, emulsion, polyurethane (PU) or thermoplastic polyurethane (TPU), etc., wherein the flexible layer 1 is comprised of single pattern or multiple block patterns.

The adhesion layer 2 is made of adhesive flexible material, such as hot-melt adhesive or thermoplastic resin, wherein a profile of the adhesion layer 2 corresponds to the flexible layer 1 so that the adhesive layer 2 matingly covers on the top of the flexible layer 1.

The fluff layer 3 is defined between the flexible layer 1 and the adhesion layer 2 and is configured to connect the flexible layer 1 with the adhesion layer 2, wherein the fluff layer 3 includes multiple fluffs 31, one ends of which are flocked on the top of the flexible layer 1, and the adhesion layer 2 covers the top of the flexible 1 so that the other ends of the multiple fluffs 31 flocked into the adhesion layer 2.

Thereby, the fluff layer 3 connects the flexible layer 1 and the adhesion layer 2 matingly and firmly.

To protect patters of the flexible layer 1, a release film 4 is attached to a bottom of the flexible layer 1 so as to avoid dusts attaching on the bottom of the flexible layer 1, thus maintaining aesthetic appearance.

The graphical heat transfer printing structure 100 is printed on objects in a heat transfer printing manner, and the release film 4 is removed so that the patterns of the flexible layer 1 present on the objects, such as fabrics or utensils, etc.

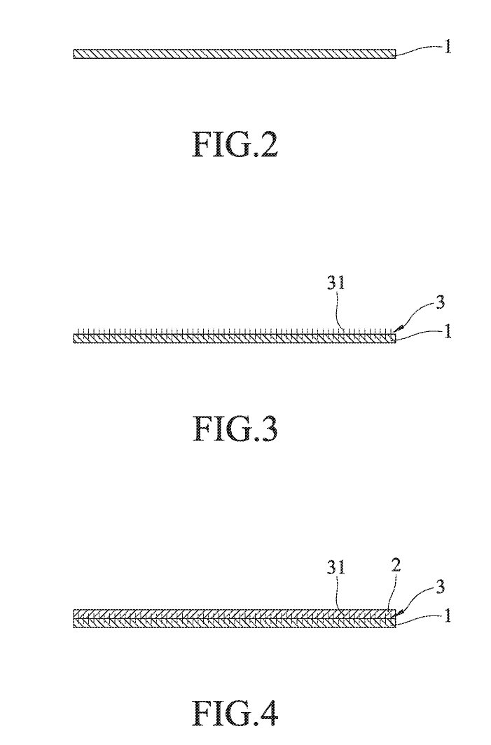

Referring to FIGS. 2-4, a method of making the graphical heat transfer printing structure 100 comprises steps of:

printing the flexible material on the release film 4 so as to form the flexible layer 1 of specific thickness and color, wherein the flexible materials are mixed at a predetermined ratio and a specific color, and the flexible materials are emulsion, polyurethane (PU) or thermoplastic polyurethane (TPU), etc.;

flocking the multiple fluffs 31 on the top of the flexible layer 1 so that the fluff layer 3 comprised of the multiple fluffs 31 forms on the top of the flexible layer 1; and

printing adhesive flexible material (such as the hot-melt adhesive or thermoplastic resin) on the top of the flexible layer 1 so that the adhesive layer 2 matingly covers on the top of the flexible layer 1.

Thereby, the fluff layer 3 is defined between the flexible layer 1 and the adhesion layer 2 and is configured to connect the flexible layer 1 with the adhesion layer 2, thus connecting the flexible layer 1 and the adhesion layer 2 firmly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A graphical heat transfer printing structure comprising:
a flexible layer made of flexible materials;
an adhesion layer made of adhesive flexible material covering on a top of the flexible layer; and
a fluff layer defined between the flexible layer and the adhesion layer, the fluff layer including multiple fluffs flocked on the flexible layer and into the adhesion layer.

2. The graphical heat transfer printing structure as claimed in claim 1, wherein the flexible layer is made of any one of silicone, emulsion, polyurethane (PU) and thermoplastic polyurethane (TPU).

3. The graphical heat transfer printing structure as claimed in claim 1, wherein the adhesion layer is made of hot-melt adhesive or thermoplastic resin.

4. The graphical heat transfer printing structure as claimed in claim 1, wherein a release film is attached to a bottom of the flexible layer.
